(19) United States
(12) Patent Application Publication
(10) Pub. No.: US 2022/0051004 A1
(43) Pub. Date: Feb. 17, 2022

(54) IMAGE PROCESSING METHOD, APPARATUS, DEVICE AND STORAGE MEDIUM

(71) Applicant: Beijing Baidu Netcom Science Technology Co., Ltd., Beijing (CN)

(72) Inventor: Qingyue MENG, Beijing (CN)

(21) Appl. No.: 17/514,125

(22) Filed: Oct. 29, 2021

(30) Foreign Application Priority Data
Nov. 27, 2020 (CN) 202011363609.7

(51) Int. Cl. G06K 9/00; G06N 3/08; G06T 7/73

(52) U.S. Cl. CPC G06K 9/00342; G06K 9/00362; G06K 9/00355; G06T 7/75; G06N 3/08

(57) ABSTRACT

The present application discloses an image processing method, an apparatus, a device and a storage medium, and relate to computer vision, augmented reality and deep learning technology in the field of computer technology. A specific implementation includes: determining, by a detection model, a 3D thermal distribution map and a 3D position offset of body key points of a target character in an image to be detected, determining predicted 3D coordinates of the body key points based on the 3D thermal distribution map of the body key points, correcting the predicted 3D coordinates according to the 3D position offset of the body key points, so that accurate 3D coordinates of the body key points can be obtained, and performing corresponding processing according to the gesture or motion of the target character.

### CROSS-REFERENCE TO RELATED APPLICATIONS

This application claims priority to Chinese Patent Application No. 202011363609.7, filed on Nov. 27, 2020 and entitled “IMAGE PROCESSING METHOD, APPARATUS, DEVICE AND STORAGE MEDIUM”, which is hereby incorporated by reference in its entirety.

### TECHNICAL FIELD

This application relates to computer vision, augmented reality, and deep learning technology in the field of computer technology, and in particular to an image processing method, an apparatus, a device and a storage medium.

### BACKGROUND

With the popularization of human-computer interaction applications, accurately obtaining body key points has become one of the key technologies. For example, in the fields of motion sensing games, human motion analysis, and avatar driving, it is very important to acquire three dimensional (3D) body key points of a human body accurately.

In the prior art, for simple deployment, color image data is generally obtained using a single common camera, 3D body key points of a human body is generally obtained based on deep learning model detection, specifically by recognizing features of RGB images to recognize body key points of a human body. However, the existing recognition methods often have large errors and the recognition is inaccurate, which affects the accuracy of the recognition of body gesture or motion based on 3D body key points, resulting in inaccurate recognition of the intention of the user's gesture or motion, and affecting the effect of human-computer interaction for the user.

### SUMMARY

The present application provides an image processing method, an apparatus, a device and a storage media.

According to a first aspect of the present application, an image processing method is provided, including: in response to a detection instruction with respect to body key points of a target character in an image to be detected, inputting the image to be detected into a detection model, and determining a 3D thermal distribution map and a 3D position offset of the body key points, where the detection model is obtained by training a neural network according to a training set; determining predicted 3D coordinates of the body key points according to the 3D thermal distribution map; correcting the predicted 3D coordinates of the body key points according to the 3D position offset to obtain final 3D coordinates of the body key points; and recognizing a gesture or motion of the target character according to the final 3D coordinates of the body key points, and performing corresponding processing according to the gesture or motion of the target character.

According to another aspect of the present application, an image processing method is provided, including: inputting a sample image in a training set into a neural network, and determining a 3D thermal distribution map and a predicted value of a 3D position offset of body key points of a character object in the sample image; determining a predicted value of 3D coordinates of the body key points according to the 3D thermal distribution map of the body key points; calculating a loss value of the neural network according to label data of the sample image as well as the predicted value of the 3D coordinates and the predicted value of the 3D position offset of the body key points; and updating a parameter of the neural network according to the loss value of the neural network.

According to another aspect of the present application, an image processing apparatus is provided, including: a detection model module configured to, in response to a detection instruction with respect to body key points of a target character in an image to be detected, input the image to be detected into a detection model, and determine a 3D thermal distribution map and a 3D position offset of the body key points, where the detection model is obtained by training a neural network according to a training set; a 3D coordinate predicting module configured to determine predicted 3D coordinates of the body key points according to the 3D thermal distribution map; a 3D coordinate correcting module configured to correct the predicted 3D coordinates of the body key points according to the 3D position offset to obtain final 3D coordinates of the body key points; and a recognition applying module configured to recognize a gesture or motion of the target character according to the final 3D coordinates of the body key points, and performing corresponding processing according to the gesture or motion of the target character.

According to another aspect of the present application, an image processing apparatus is provided, including: a neural network module configured to input a sample image in a training set into a neural network, and determine a 3D thermal distribution map and a predicted value of a 3D position offset of body key points of a character object in the sample image; a 3D coordinate determining module configured to determine a predicted value of 3D coordinates of the body key points according to the 3D thermal distribution map of the body key points; a loss determining module configured to calculate a loss value of the neural network according to label data of the sample image as well as the predicted value of the 3D coordinates and the predicted value of the 3D position offset of the body key points; and a parameter updating module configured to update a parameter of the neural network according to the loss value of the neural network.

According to another aspect of the present application, an image processing apparatus is provided, including: at least one processor; and a memory communicatively connected to the at least one processor; where, the memory stores instructions executable by the at least one processor, and the instructions are executed by the at least one processor to enable the at least one processor to execute the method according to any one of the above embodiments.

According to another aspect of the present application, a non-transitory computer-readable storage medium having computer instructions stored thereon is provided, where the computer instructions are used to cause the computer to execute the method according to any one of the aspects above.

According to the technology of the present application, the recognition accuracy of the gesture or motion of the person is improved.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF DRAWINGS

The drawings are used to better understand the solutions, and do not constitute a limitation on the present application, where:

FIG. 1 is a scenario graph of image processing according to an embodiment of the present application;

FIG. 2 is a flowchart of an image processing method provided by a first embodiment of the present application;

FIG. 3 is a schematic flowchart of a detection for body key points provided by a second embodiment of the present application;

FIG. 4 is a schematic flowchart of another detection for body key points provided by the second embodiment of the present application;

FIG. 5 is a flowchart of an image processing method provided by the second embodiment of the present application;

FIG. 6 is a flowchart of an image processing method provided by a third embodiment of the present application;

FIG. 7 is a flowchart of an image processing method provided by a fourth embodiment of the present application;

FIG. 8 is a schematic diagram of an image processing apparatus provided by a fifth embodiment of the present application;

FIG. 9 is a schematic diagram of an image processing apparatus provided by a seventh embodiment of the present application;

FIG. 10 is a schematic diagram of an image processing apparatus provided by an eighth embodiment of the present application;

FIG. 11 is a block diagram of an electronic device used to implement an image processing method of an embodiment of the present application.

### DESCRIPTION OF EMBODIMENTS

Exemplary embodiments of the present application are described below with reference to the accompanying drawings, where various details of the embodiments of the present application are included to facilitate understanding, and should be considered as merely exemplary. Therefore, those of ordinary skill in the art should recognize that various changes and modifications can be made to the embodiments described herein without departing from the scope and spirit of the present application. Similarly, for clarity and conciseness, descriptions of well-known functions and structures are omitted in the following description.

The present application provides an image processing method, an apparatus, a device and a storage medium, which are applied to computer vision, augmented reality, and deep learning technology in the field of computer technology, so as to improve the recognition accuracy of character gesture or motion and improve the effect of human-computer interaction.

The image processing method provided by the embodiments of the present application is at least applied to the fields of motion sensing game, human motion analysis, avatar driving, etc., and can be specifically applied to products, such as fitness supervision or guidance, intelligent education, special effects for live streaming and 3D motion sensing game.

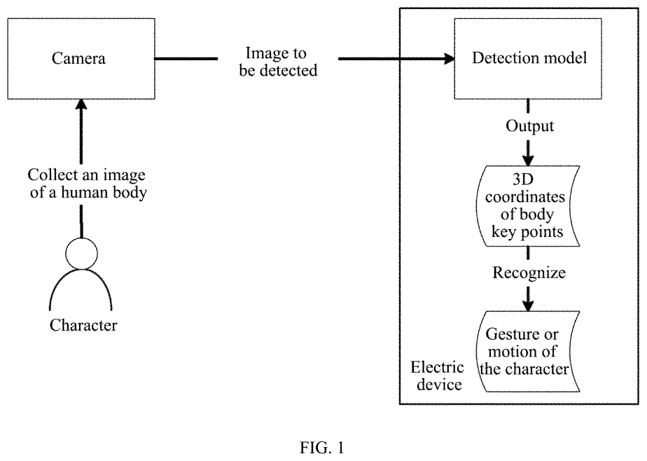

In a possible application scenario, as shown in FIG. 1, a two-dimensional (2D) image of a complete body including a target object is collected through a preset camera, and the 2D image is transmitted to an electronic device for image processing. The electronic device inputs the user's 2D image as an image to be detected into a pre-trained detection model; determines a 3D thermal distribution map and a 3D position offset of the user's body key points in the image through the detection model; then determines predicted 3D coordinates of the body key points according to the 3D thermal distribution map; and corrects the predicted 3D coordinates of the body key points according to the 3D position offset to obtain final 3D coordinates of the body key points. After determining the 3D coordinates of the user's body key points in the collected 2D image, user's gesture or motion is recognized based on the 3D coordinates of the user's body key points. The electronic device determines the interactive information corresponding to the user's gesture or motion based on preset rules, and responds to the user based on the interactive information.

Among them, the electronic device may be a device used to perform an image processing method, and the device may be different when applied to different technical fields and application scenarios. For example, it may be motion sensing game machine, human motion analysis device, monitoring device for intelligent teaching, etc. The camera used to collect the user's image can be a common monocular camera, which can reduce cost.

For example, when the image processing method is applied to the field of motion sensing game, the user interacts with the motion sensing game device by making prescribed gesture or motion within a shooting range of a camera of the motion sensing game device. The motion sensing game device inputs the user's 2D image to the detection model as the image to be detected based on the 2D image including the user's complete body collected by the camera; determines and outputs the 3D thermal distribution map and the 3D position offset of the user's body key points in the 2D image through the detection model; determines the predicted 3D coordinates of the body key points according to the 3D thermal distribution map; corrects the predicted 3D coordinates of the body key points to obtain the final 3D coordinates of the body key points according to the 3D position offset; and then recognizes the user's gesture or motion in the collected 2D image according to the final 3D coordinates of the body key points. In a motion sensing game, after recognizing the gesture or motion of the user, instruction information corresponding to the user's gesture or motion can be determined, and make game response to the user according to the instruction information corresponding to the user's gesture or motion.

For example, when the image processing method is applied to an intelligent teaching scenario, an image of a teacher's body can be collected in real time during teaching by a camera preset in a classroom to form recorded video data. The monitoring system can use the image processing method provided in the embodiments of the present application to perform image processing on one or more frames of the video data; detect 3D coordinates of the teacher's body key points in the image; recognize the teacher's gesture or motion based on the 3D coordinates of the teacher's body key points, and analyze the teacher's gesture or motion in one or more frames of images to determine whether the teacher has made an unqualified behavior. If it is determined that the teacher makes an unqualified behavior in teaching, the determination result is reported in time.

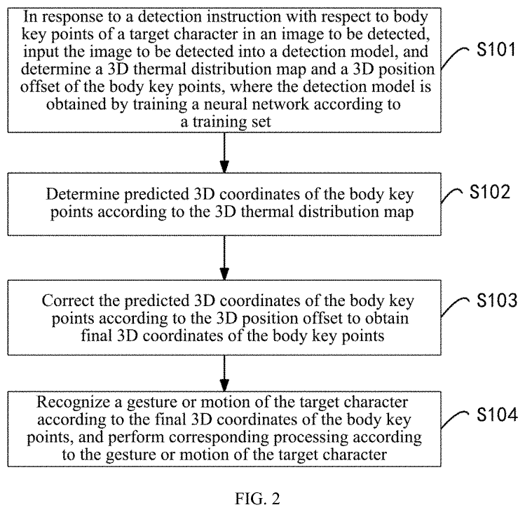

FIG. 2 is a flowchart of an image processing method provided by a first embodiment of the present application. As shown in FIG. 2, the specific steps of the method are as follows.

S101: in response to a detection instruction with respect to body key points of a target character in an image to be detected, input the image to be detected into a detection model, and determine a 3D thermal distribution map and a 3D position offset of the body key points, where the detection model is obtained by training a neural network according to a training set.

Among them, the in response to a detection instruction with respect to body key points of a target character in an image to be detected, input the image to be detected into a detection model may be that the user inputs the image to be detected into the electronic device and issue an instruction to start the detection, or it may be a trigger to start detection after the image to be detected is ready.

In this embodiment, the image to be detected may be a 2D image, an image taken by a common monocular camera or a 2D image obtained in other ways.

The detection model is a neural network model pre-trained according to a training set. The detection model uses multiple 2D convolution kernels to perform image processing on the input 2D image, and finally outputs a 3D thermal distribution map and a 3D position offset of the body key points of the target character in the 2D image in a given three-dimensional space.

In the process of acquiring the 3D thermal distribution map, a series of processes, such as feature extraction and transformation are performed on the 2D image, which will cause offset of the coordinates of the body key points. In this embodiment, the 3D position offset of the body key points is determined while the 3D thermal distribution map of the body key points is obtained.

Step S102: determine predicted 3D coordinates of the body key points according to the 3D thermal distribution map.

Among them, the 3D thermal distribution map is a probability distribution of the body key points in various positions of a three-dimensional space. Among them, the three-dimensional space is a three-dimensional space of a given range, for example, the given range can be 64×64×64, and then the three-dimensional space is a three-dimensional space of 64×64×64.

After the 3D thermal distribution map of the body key points in the given three-dimensional space is determined, the most likely location point of the body key points is determined according to the 3D thermal distribution map, and 3D coordinates of the location point is used as the predicted 3D coordinates of the body key points.

Step S103: correct the predicted 3D coordinates of the body key points according to the 3D position offset to obtain final 3D coordinates of the body key points.

After the predicted 3D coordinates of the body key points is determined according to the 3D thermal distribution map, the predicted 3D coordinates are corrected according to the 3D position offset to obtain the final 3D coordinates of the body key points.

Step S104: recognize a gesture or motion of the target character according to the final 3D coordinates of the body key points, and perform corresponding processing according to the gesture or motion of the target character.

After the 3D coordinates of the body key points is detected, the gesture or motion of the target character can be recognized according to the final 3D coordinates of the body key points.

In different application scenarios, interaction information corresponding to the gesture or motion of the target character is different. Combined with specific application scenarios, the interaction information corresponding to the gesture or motion of the target character is determined, and corresponding processing is made based on the interaction information corresponding to the gesture or motion of the target character, and response is made with respect to the gesture or motion of the target character.

The embodiment of the present application, by determining, by a detection model, a 3D thermal distribution map and a 3D position offset of body key points of a target character in an image to be detected according to the input image to be detected, determining predicted 3D coordinates of the body key points based on the 3D thermal distribution map of the body key points, and correcting the predicted 3D coordinates according to the 3D position offset of the body key points, can obtain accurate 3D coordinates of the body key points, thereby realizing accurate detection of the body key points, and can recognize a gesture or motion of the target character accurately based on the accurate 3D coordinates of body key points, and by performing corresponding processing according to the gesture or motion of the target character, improves the recognition accuracy of the gesture or motion of the target character, can accurately recognize the intention of the target character, and can improve the interaction effect with the target character.

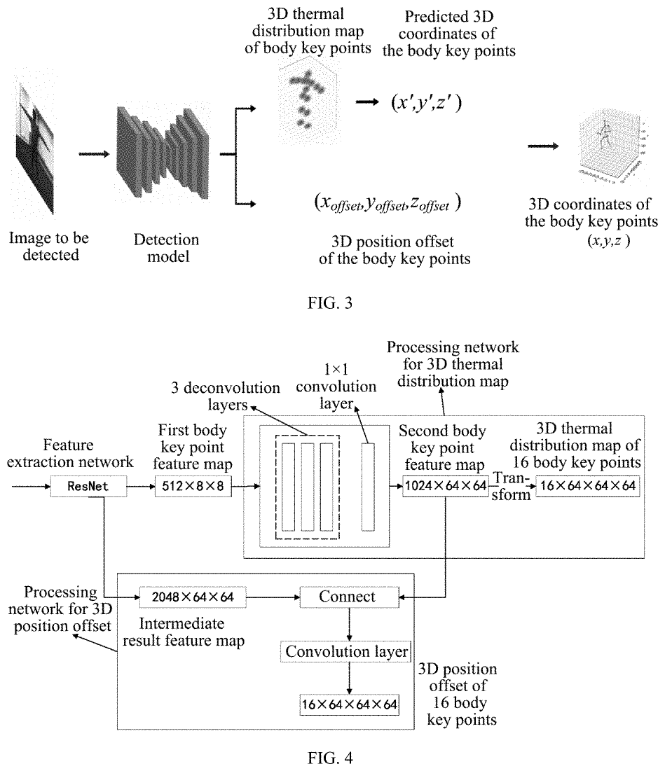

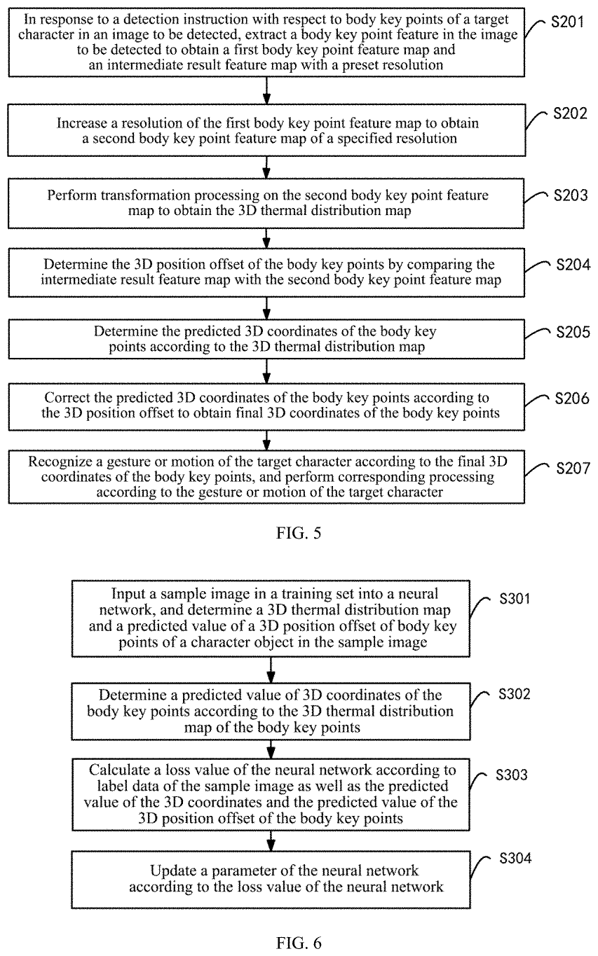

FIG. 3 is a schematic flowchart of a detection for body key points provided by a second embodiment of the present application; FIG. 4 is a schematic flowchart of another detection for body key points provided by the second embodiment of the present application; FIG. 5 is a flowchart of an image processing method provided by the second embodiment of the present application. On the basis of the above-mentioned first embodiment, in this embodiment, the image processing method will be described in detail in combination with the structure of the detection model.

As shown in FIG. 3, the overall process of the detection for body key points includes: inputting a 2D image to be detected into a detection model, where the detection model has two branch outputs, one of which is a 3D thermal distribution map of N body key points of the target character in the 2D image, so that predicted 3D coordinates (x′, y′, z′) of the corresponding body key points can be determined based on each 3D thermal distribution map; and the other one of which is a 3D position offset (x_{offset},y_{offset},z_{offset}) of the N body key points; and then correcting the predicted 3D coordinates (x′, y′, z′) of the body key points through the 3D position offset (x_{offset},y_{offset},z_{offset}) of the body key points to obtain 3D coordinates (x, y, z) of the N body key points so as to complete the detection for the body key points. Among them, N is a preset number of body key points, for example, N can be 16 or 21, etc., which is not specifically limited herein.

The overall process of body key points detection will be described in more detail below combined with the structure of the detection model. As shown in FIG. 4, the detection model for body key points in the embodiment includes a feature extraction network, a processing network for 3D thermal distribution map, and a processing network for 3D position offset. In the embodiment, taking 16 body key points as an example for exemplary illustration, when the body key points change, the overall framework of the current model remains unchanged, and a resolution of the feature map therein may change.

Among them, the feature extraction network is used to extract a body key point feature in the image to be detected, and output a first body key point feature map and an intermediate result feature map with a preset resolution. The feature extraction network can be implemented by neural networks capable of extracting image features, such as ResNet, VGG (Visual Geometry Group Network), etc., which is not specifically limited herein. The preset resolution can be set according to the given range of the three-dimensional space where the 3D thermal distribution map is located and the number of body key points in the actual application scenario. For example, the given range of the three-dimensional space where the 3D thermal distribution map is located can be 64×64×64, the number of body key points is 16, and the preset resolution can be 2048×64×64 or 1024×64×64. In FIG. 4, the feature extraction network is ResNet, a resolution of the output first body key point feature map is 512×8×8, and the resolution of the intermediate result feature map is 2048×64×64 as an example for illustration.

The processing network for 3D thermal distribution map includes at least one deconvolution network (the three deconvolution layers as shown in FIG. 4) and a 1×1 convolution layer. The first body key point feature map is passed through at least one deconvolution layer to increase the resolution of the first body key point feature map to obtain a third body key point feature map; perform feature extraction on a body key point feature in the third body key point feature map again through the 1×1 convolution layer to obtain a second body key point feature map. The second body key point feature map is transformed to obtain a 3D thermal distribution map of a specified dimension. Among them, the number of the deconvolution layers can be set according to actual application scenarios, and three deconvolution layers can be used in the embodiment. The transformation processing can be realized through a reshape function, which transforms a matrix corresponding to the feature map of the second body key points into a 3D thermal distribution map with a specific dimension matrix. FIG. 4 can includes 3 deconvolution layers, the processing of transformation uses the reshape function, and the second body key point feature map of 1024×64×64, which is output after processing by the 3 deconvolution layers and the 1×1 convolution layer, will be reshaped into 16×64×64×64 to obtain a 3D thermal distribution map of 16 body key points.

The processing network for 3D position offset is configured to connect the intermediate result feature map of the feature extraction network with the preset resolution and the second body key point feature map of the processing network for 3D thermal distribution map for inputting into a convolution layer, and determine the 3D position offset of the body key points by comparing the intermediate result feature map with the second body key point feature map through the convolution layer. In FIG. 4, the intermediate result feature map of 2048×64×64 is connected with the second body key point feature map of 1024×64×64 for inputting into the convolutional layer to obtain the 3D position offset of 16 body key points.

The flow of the image processing method will be described in more detail with reference to FIG. 5 below. As shown in FIG. 5, the specific steps of the image processing method are as follows.

S201: in response to a detection instruction with respect to body key points of a target character in an image to be detected, extract a body key point feature in the image to be detected to obtain a first body key point feature map and an intermediate result feature map with a preset resolution.

Among them, in response to the detection instruction with respect to the body key points of the target character in the image to be detected, input the image to be detected into the detection model may be that the user inputs the image to be detected into the electronic device and issue an instruction to start the detection, or it may be a trigger to start detection after the image to be detected is ready.

In this embodiment, the image to be detected may be a 2D image, an image taken by a common monocular camera or a 2D image obtained in other ways.

After the image to be detected is input into the detection model, firstly the body key point feature of the image to be detected is extracted through the feature extraction network to obtain the first body key point feature map. In this step, the feature extraction network used to extract the feature of body key points in the image to be detected to obtain the feature map of the first body key points can be implemented by neural networks capable of extracting image features, such as ResNet, VGG (Visual Geometry Group Network), etc., which is not specifically limited herein.

In addition, this step also needs to acquire an intermediate result with the preset resolution in the process of extracting the first body key point feature map as the intermediate result feature map, which is used to determine the 3D position offset of the body key points subsequently.

Step S202: increase a resolution of the first body key point feature map to obtain a second body key point feature map with a specified resolution.

In the embodiment, this step can be implemented in the following manner: pass the first body key point feature map through at least one deconvolution layer to increase the resolution of the first body key point feature map to obtain a third body key point feature map; and perform feature extraction on a body key point feature in the third body key point feature map through a 1×1 convolution layer to obtain the second body key point feature map.

After obtaining the first body key point feature map, the resolution of the first body key point feature map is usually small. In order to improve the accuracy of the predicted 3D coordinates of the body key points, the resolution of the first body key point feature map is increased to obtain a third body key point feature map, and then feature extraction is performed on a body key point feature in the third body key point feature map through a 1×1 convolution layer again to obtain the second body key point feature map, which can increase the resolution of the feature map and strengthen the body key point feature, thereby enabling a better fusion of the image features. The 3D thermal distribution map of the body key points determined according to the second body key point feature map improves the accuracy of the predicted 3D coordinates determined based on the 3D thermal distribution map of the body key points.

Among them, the specified resolution is greater than the resolution of the first body key point feature map, which can be set according to the given range of the three-dimensional space where the 3D thermal distribution map is located and the number of body key points in the actual application scenario, for example, the given range of the three-dimensional space where the 3D thermal distribution map is located can be 64×64×64, the number of body key points is 16, and the specified resolution can be (16×64)×64×64, ie. 1024×64×64.

Among them, the number of deconvolution layers can be set according to actual application scenarios, for example, 3 deconvolution layers can be used.

Step S203: perform transformation processing on the second body key point feature map to obtain the 3D thermal distribution map.

After the second body key point feature map with the specified resolution is obtained, the 3D thermal distribution map of each body key point is obtained by performing transformation processing on the second body key point feature map.

Among them, the transformation processing can be realized through a reshape function, which transforms a matrix corresponding to the feature map of the second body key points into a 3D thermal distribution map with a specific dimension matrix.

For example, as shown in FIG. 4, the second body key point feature map of 1024×64×64 can be reshaped into 16×64×64×64 to obtain a 3D thermal distribution map of 16 body key points.

S204: determine the 3D position offset of the body key points by comparing the intermediate result feature map with the second body key point feature map.

In the process of acquiring the 3D thermal distribution map, a series of processes, such as feature extraction and transformation are performed on the 2D image, which will cause offset of the coordinates of the body key points. In this embodiment, the 3D position offset of the body key points is determined while the 3D thermal distribution map of the body key points is obtained.

This step can be implemented specifically in the following ways:

connect the intermediate result feature map with the second body key point feature map for inputting into a convolution layer, and determine the 3D position offset of the body key points by comparing the intermediate result feature map with the second body key point feature map through the convolution layer. In this way, by comparing the high-resolution intermediate result feature map of the body key points in the feature extraction stage is obtained from the feature extraction network, with the high-resolution second body key point feature map configured to directly generate the 3D thermal distribution map of each body key point, the 3D position offset of the body key points, resulting from the processing performed on the feature map beginning from the feature extraction to the determination of the 3D thermal distribution map of the body key points, can be accurately determined, which improves the accuracy of the 3D position offset of the body key points, and the predicted 3D coordinates of the body key points are corrected based on the 3D position offset, so that the obtained 3D coordinates of the body key points become more accurate.

In this embodiment, through the above steps S201-S204, in response to the detection instruction with respect to the body key points of the target character in the image to be detected, the image to be detected is input into the detection model, so as to determine the 3D thermal distribution map and the 3D position offset of body key points of the target character in the image to be detected. The detection model is a neural network model pre-trained according to a training set. The detection model uses multiple 2D convolution kernels to perform image processing on the input 2D image, and finally outputs a 3D thermal distribution map and a 3D position offset of the body key points of the target character in the 2D image in a given three-dimensional space. Among them, the specific training process of the detection model can be implemented by using the method flow provided in the third embodiment, reference may be made to the third embodiment, which will not be repeated herein.

Step S205: determine the predicted 3D coordinates of the body key points according to the 3D thermal distribution map.

Among them, the 3D thermal distribution map is a probability distribution of the body key points in various positions of a three-dimensional space. Among them, the three-dimensional space is a three-dimensional space of a given range, for example, the given range can be 64×64×64, and then the three-dimensional space is a three-dimensional space of 64×64×64.

After the 3D thermal distribution map of the body key points in the given three-dimensional space is determined, the most likely location point of the body key points is determined according to the 3D thermal distribution map, and 3D coordinates of the location point is used as the predicted 3D coordinates of the body key points.

This step can be implemented in the following ways:

determine a maximum value of the probability distribution and 3D coordinates of a location point corresponding to the maximum value using a softargmax method; and determine the 3D coordinates of the location point corresponding to the maximum value as 3D coordinates of the body key points.

Optionally, before determining the 3D coordinates of the body key points, the 3D thermal distribution map of each body key point can be normalized, so that each value in the 3D thermal distribution map is mapped to (0, 1), so that each normalized 3D thermal distribution map represents that the body key points are Gaussian distribution in a given three-dimensional space, in which the size of each 3D thermal distribution map is determined according to the size of the given three-dimensional space. Then a maximum value of the Gaussian distribution and 3D coordinates of a location point corresponding to the maximum value is determined using the softargmax method based on the normalized 3D thermal distribution map; and the 3D coordinates of the location point corresponding to the maximum value is determined as the 3D coordinates of the body key points. The method of finding the position of the extreme value through the softargmax method is differentiable, and the obtained 3D coordinates of the body key points are more accurate.

Optionally, the 3D thermal distribution map of each body key point can be normalized through the softmax function, or can be realized using other normalization methods.

S206: correct the predicted 3D coordinates of the body key points according to the 3D position offset to obtain final 3D coordinates of the body key points.

When determining the transformation between the predicted 3D coordinates of the body key points and the 3D position offset, the predicted 3D coordinates of the body key points can be corrected according to the following formula 1 to obtain the final 3D coordinates of the body key points:

P_{final}=Pₒᵤₜₚᵤₜ+ΔP Formula 1

where, Pₒᵤₜₚᵤₜ represents the predicted 3D coordinates of the body key points determined according to the 3D thermal distribution map of the body key points, ΔP represents the offset corresponding to the coordinate values of each body key point, and P_{final} represents the corrected final 3D coordinates of the body key points.

Step S207: recognize a gesture or motion of the target character according to the final 3D coordinates of the body key points, and perform corresponding processing according to the gesture or motion of the target character.

After the 3D coordinates of the body key points is detected, the gesture or motion of the target character can be recognized according to the final 3D coordinates of the body key points.

In different application scenarios, the interaction information corresponding to the gesture or motion of the target character is different. Combined with specific application scenarios, the interaction information corresponding to the gesture or motion of the target character is determined, and corresponding processing is made based on the interaction information corresponding to the gesture or motion of the target character, and response is made with respect to the gesture or motion of the target character.

The embodiment of the present application, by extracting a body key point feature in the image to be detected to obtain a first body key point feature map and an intermediate result feature map with a preset resolution; increasing a resolution of the first body key point feature map to obtain a second body key point feature map with a specified resolution; performing transformation processing on the second body key point feature map to obtain the 3D thermal distribution map; determining predicted 3D coordinates of the body key points according to the 3D thermal distribution map; and determining the 3D position offset of the body key points by comparing the intermediate result feature map with the second body key point feature map, can accurately determine the predicted 3D coordinates and the 3D position offset of the body key points; furthermore, the 3D thermal distribution map is a probability distribution of the body key points in various positions of a three-dimensional space, the embodiment of the present application, by determining a maximum value of the probability distribution and 3D coordinates of a location point corresponding to the maximum value using a softargmax method; and determining the 3D coordinates of the location point corresponding to the maximum value as 3D coordinates of the body key points, improves the accuracy of the predicted 3D coordinates and the accuracy of the 3D coordinates of the body key points, and can recognize a gesture or motion of the target character accurately based on the accurate 3D coordinates of body key points, and by performing corresponding processing according to the gesture or motion of the target character, improves the recognition accuracy of the gesture or motion of the target character, can accurately recognize the intention of the target character, and can improve the interaction effect with the target character.

FIG. 6 is a flowchart of an image processing method provided by a third embodiment of the present application. The training method of detection model for the body key points will be mainly described in detail in the embodiment. As shown in FIG. 6, the image processing method trains the neural network by performing the following steps in a loop, and the trained neural network is used as the final detection model for the body key points.

S301: input a sample image in a training set into a neural network, and determine a 3D thermal distribution map and a predicted value of a 3D position offset of body key points of a character object in the sample image.

Among them, the training set includes a sample image and label data corresponding to the sample image. Among them, the label data of the sample image includes 3D coordinates and a 3D position offset of body key points of a character object in the sample image, which are pre-labeled.

In the process of training the neural network, the sample image is input into the neural network every time it is trained to determine the 3D thermal distribution map and the predicted value of the 3D position offset of the body key points of the character object in the sample image.

Step S302: determine a predicted value of 3D coordinates of the body key points according to the 3D thermal distribution map of the body key points.

Among them, the 3D thermal distribution map is a probability distribution of the body key points in various positions of a three-dimensional space. Among them, the three-dimensional space is a three-dimensional space of a given range, for example, the given range can be 64×64×64, and then the three-dimensional space is a three-dimensional space of 64×64×64.

After the 3D thermal distribution map of the body key points in the given three-dimensional space is determined, the most likely location point of the body key points is determined according to the 3D thermal distribution map, and 3D coordinates of the location point is used as the predicted value of the 3D coordinates of the body key points.

S303: calculate a loss value of the neural network according to label data of the sample image as well as the predicted value of the 3D coordinates and the predicted value of the 3D position offset of the body key points.

After the predicted value of the 3D coordinates and the predicted value of the 3D position offset of the body key points of the character object in the sample image are determined, a comprehensive loss value of the 3D coordinates and the 3D position offset is calculated according to the 3D coordinates and the 3D position offset of the body key points of the character object in the sample image, which are labeled, in the label data of the sample image to obtain the loss value of the neural network.

S304: update a parameter of the neural network according to the loss value of the neural network.

After the loss value of the current neural network is obtained by calculation, the loss value of the neural network updates the parameter of the neural network.

After the parameter of the neural network is updated, whether the neural network converges is tested through a test set; if the neural network converges, the training ends, and the trained neural network is used as the detection model for the body key points; if the neural network does not converge, it continues to train the neural network until the neural network converges.

When the image processing method is applied to specific application scenarios, the detection model for the body key points is used to determine the 3D thermal distribution map and 3D position offset of the body key points of the target character in the image to be detected. Accurate 3D coordinates of the body key points can be determined according to the determined 3D thermal distribution map and 3D position offset of the body key points of the target character, a gesture or motion of the target character can be recognized according to the accurate 3D coordinates of the body key points, and corresponding processing is performed according to the gesture or motion of the target character, so as to realize the specific function of the corresponding application scenario.

The embodiment of the present application trains the detection model for the body key points by using the pre-obtained training set, where the trained detection model can accurately detect the 3D thermal distribution map and 3D position offset of the body key points of the character object in the input image, so that the accurate 3D coordinates of the body key points can be determined.

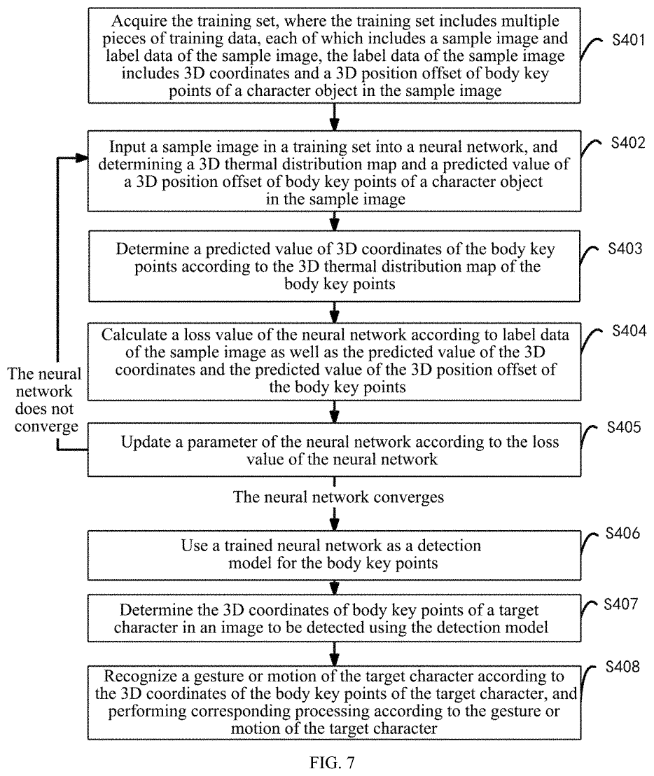

FIG. 7 is a flowchart of an image processing method provided by a fourth embodiment of the present application. On the basis of the above-mentioned third embodiment, in this embodiment, the image processing method is described in detail in combination with the structure of the detection model. The mechanism of the neural network in the embodiment is the same as that shown in FIG. 4 in the above-mentioned second embodiment, which will not be repeated herein.

As shown in FIG. 7, the specific steps of the method are as follows.

S401: acquire the training set, where the training set includes multiple pieces of training data, each of which includes a sample image and label data of the sample image, the label data of the sample image includes 3D coordinates and a 3D position offset of body key points of a character object in the sample image.

In the embodiment, this step can be implemented in the following ways: acquire a sample image as well as true 3D coordinates and a type of body key points of a character object in the sample image, which are pre-labeled; perform data enhancement on the true 3D coordinates of the body key points to determine a sample value of 3D coordinates of the body key points; calculate a 3D position offset of the sample value of the 3D coordinates of the body key points with respect to the true 3D coordinates; and generate label data of the sample image according to the sample value of the 3D coordinates of the body key points, the type of the body key points, which is pre-labeled, and the 3D position offset of the sample value of the 3D coordinates of the body key points with respect to the true 3D coordinates, where the sample image and the label data thereof constitute a piece of training data. Among them, the type of body key points includes eyes, jaw, nose, neck, shoulders, wrists, elbows, ankles, knees, etc., which will not be listed herein.

In the embodiment, a data set configured to the detect body key points can be acquired as an original data set, the original data set includes a sample image as well as real 2D coordinates (x, y) and a type of the body key points of the character object in the sample image, which are pre-labeled. The label data of the sample image is then relabeled based on the original data set, so as to obtain the training set required by the embodiment of the present application.

Firstly, the real 2D coordinates (x, y) of the body key points of the character object in the sample image in the original data set are pixel coordinates of the body key points in the sample image. In the embodiment, a z-axis represents a distance of each body key point in depth relative to 0 point on z-axis, where a certain body key point is taken as the 0 point on z-axis. The unit of the distance in depth can be meters and so on. Among them, the body key point taken as the 0 point on z-axis can be pre-designated according to actual application scenarios, for example, a pelvic key point located in the middle of the human body, etc., and will not change during model training and model applying after assigned.

Distance of other body key points in depth relative to the body key point taken as the 0 point on z-axis is determined as z-axis coordinates of the body key points, according to depth information of the sample image and depth information of the body key points taken as the 0 point on z-axis, so as to obtain the true 3D coordinates (x, y, z) of the body key points of the character object in the sample image.

Then, data enhancement is performed on the true 3D coordinates of the body key points of the character object in the sample image in the original data set to determine the sample value of the 3D coordinates of the body key points; and the 3D position offset of the 3D coordinates caused by the previous data enhancement process is determined. The label data of the sample image is generated according to the sample value of the 3D coordinates of the body key points, the type of the body key points, which is pre-labeled, and the 3D position offset of the sample value of the 3D coordinates of the body key points with respect to the true 3D coordinates, where the sample image and the label data thereof constitute a piece of training data. In this way, the training set, which can be applied to the embodiments of the present application, can be obtained, and the training of the neural network provides rich training data, which improves the sample diversity in the training set.

For example, the real 3D coordinates of the body key point B in the sample image A is (x1, y1, z1), and data enhancement is performed on the real 3D coordinates of the sample image A to obtain the sample value (x2, y2, z2) of the 3D coordinates corresponding to the body key point B, which is to increase an error of the coordinates of the key point B in A, so that the corresponding 3D position offset can be determined as (x2-x1, y2-x1, z2-z1).

Exemplarily, at least one of the following data enhancement processing is performed on the true 3D coordinates of the body key points: exchanging true 3D coordinates of symmetrical body key points among the body key points; increasing an error value on the true 3D coordinates of the body key points according to preset rules; and taking true 3D coordinates of body key points of a first character object as a sample value of 3D coordinates of corresponding body key points of a second character object, where the first character object and the second character object are the character object in a same sample image.

Among them, the symmetrical body key points among the body key points can be the body key points that are bilateral symmetrical in the human body, such as the body key points of the left wrist and the right wrist.

Some errors of the coordinate values of each body key point of the character object in the sample image can be increased, by increasing an error value for the true 3D coordinates of body key points according to preset rules, to simulate a prediction error. Among them, the preset rules for increasing the error can be set according to actual application scenarios, for example, increasing an error of all body key points randomly; or, setting different error ranges for different types of body key points, and increasing the error value randomly within an error range, etc.

The first character object and the second character object can be two adjacent character objects in the sample image, and the true 3D coordinates of the body key points of the first character object are taken as the sample value of the 3D coordinates of the corresponding body key points of the second character object, so that some of the coordinates of the character's body key points can be shifted to the corresponding body key points of other adjacent character objects, so as to simulate a dislocation of the body key points during the prediction.

In addition, the combination of data enhancement processing can be different for coordinates of different body key points so as to improve the diversity of the sample data in the training set.

In an optional implementation, after the acquire a sample image as well as true 3D coordinates and a type of body key points of a character object in the sample image, which are pre-labeled, the method further includes: set the 3D position offset of the body key points of the character object in the sample image to 0; and generate the label data of the sample image according to the true 3D coordinates and the type of the body key points of the character object in the sample image, which are pre-labeled, and the 3D position offset set to 0, where the sample image and the label data thereof constitute a piece of training data. In this way, by setting the 3D position offset of the body key points in the sample image to 0 to generate the corresponding training data as a part of the training set, the diversity of the sample data in the training set can be increased.

After the training set is acquired, the neural network is trained by performing the following steps S402-S405 in a loop, and the trained neural network is used as the final detection model for the body key points.

Step S402: input a sample image in a training set into a neural network, and determining a 3D thermal distribution map and a predicted value of a 3D position offset of body key points of a character object in the sample image.

In this embodiment, this step can be implemented in the following ways: extract a body key point feature in the sample image to obtain a first body key point feature map and an intermediate result feature map with a preset resolution; increasing a resolution of the first body key point feature map to obtain a second body key point feature map with a specified resolution; performing transformation processing on the second body key point feature map to obtain the 3D thermal distribution map; and determine the predicted value of the 3D position offset of the body key points by comparing the intermediate result feature map with the second body key point feature map.

Furthermore, the increase a resolution of the first body key point feature map to obtain a second body key point feature map with a specified resolution includes: pass the first body key point feature map through at least one deconvolution layer to increase the resolution of the first body key point feature map to obtain a third body key point feature map; and perform feature extraction on a body key point feature in the third body key point feature map through a 1×1 convolution layer to obtain the second body key point feature map.

Furthermore, the determine the predicted value of the 3D position offset of the body key points by comparing the intermediate result feature map with the second body key point feature map, includes: connect the intermediate result feature map with the second body key point feature map for inputting into a convolution layer, and determine the predicted value of the 3D position offset of the body key points by comparing the intermediate result feature map with the second body key point feature map through the convolution layer.

In this step, the specific implementation of inputting a sample image in a training set into a neural network, and determine a 3D thermal distribution map and a predicted value of a 3D position offset of body key points of a character object in the sample image is identical to the specific implementation of inputting the image to be detected to determine a 3D thermal distribution map and a 3D position offset of body key points of a target character in an image to be detected through steps S201-S204 in the above-mentioned second embodiment, and will not be repeated herein.

Step S403: determine a predicted value of 3D coordinates of the body key points according to the 3D thermal distribution map of the body key points.

This step can be implemented in a manner similar to the above-mentioned step S205, and will not be repeated herein.

S404: calculate a loss value of the neural network according to label data of the sample image as well as the predicted value of the 3D coordinates and the predicted value of the 3D position offset of the body key points.

After the predicted value of the 3D coordinates and the predicted value of the 3D position offset of the body key points of the character object in the sample image are determined, a comprehensive loss value of the 3D coordinates and the 3D position offset is calculated according to the 3D coordinates and the 3D position offset of the body key points of the character object in the sample image, which are labeled, in the label data of the sample image to obtain the loss value of the neural network.

In this embodiment, this step can be specifically implemented in the following ways:

calculate a 3D coordinate loss and a 3D position offset loss respectively, according to the label data of the sample image, as well as the predicted value of the 3D coordinates and the predicted value of the 3D position offset of the body key points of the character object in the sample image; and determine the loss value of the neural network according to the 3D coordinate loss and the 3D position offset loss.

Optionally, the calculation of the 3D coordinate loss can be obtained by calculating an L1 loss value between the predicted value of the 3D coordinates of the body key points of the character object in the sample image and the real 3D coordinates in the label data.

Exemplarily, the calculation of the 3D coordinate loss can be obtained by the following formula 2:

Loss_{coord}=∥Coord_{pred}−Coord_{gt}∥₁ Formula 2

where, Coord_{pred} represents the predicted value of the 3D coordinates of the body key points, Coord_{gt} represents the 3D coordinates of the body key points in the label data, that is, the true value of the 3D coordinates of the body key points, and Loss_{coord} represents the L1 loss value between the predicted value and the true value of the 3D coordinates, that is, the 3D coordinate loss.

Optionally, the calculation of the 3D position offset loss can be obtained by calculating an L2 loss value between the predicted value of the 3D position offset of the body key points of the character object in the sample image and the 3D position offset in the label data.

Exemplarily, the calculation of the 3D position offset loss can be obtained by the following formula 3:

Loss_{Δ}=∥O_{pred}−O_{gt}∥₂ Formula 3

where, O_{pred} represents the predicted value of the 3D position offset of the body key points, O_{gt} represents the 3D position offset of the body key points in the label data, that is, the true value of the 3D position offset of the body key points, and Loss represents the L2 loss value between the predicted value and the true value of the 3D position offset, that is, the 3D position offset loss.

Furthermore, the determination of the loss value Loss of the neural network according to the 3D coordinate loss and the 3D position offset loss can be determined according to the following formula 4:

Loss=Loss_{coord}+Loss_{Δ} Formula 4

where, Loss represents the loss value of the neural network, Loss_{coord} represents the 3D coordinate loss, and Loss_{Δ} represents the 3D position offset loss.

S405: update a parameter of the neural network according to the loss value of the neural network.

After the loss value of the current neural network is obtained by calculation, the loss value of the neural network updates the parameter of the neural network.

After the parameter of the neural network is updated, whether the neural network converges is tested through a test set; if the neural network converges, the training ends, and step S406 is executed to use the trained neural network as the detection model for the body key points. If the neural network does not converge, it continues to train the neural network until the neural network converges.

S406: use a trained neural network as a detection model for the body key points.

The detection model for the body key points is obtained by training in this embodiment. When the image processing method is applied to specific application scenarios, the detection model for the body key points is used to determine the 3D coordinates of the body key points of the target character in the image to be detected. A gesture or motion of the target character can be recognized according to the 3D coordinates of the body key points of the determined target character, and corresponding processing is performed according to the gesture or motion of the target character, so as to realize the specific function of the corresponding application scenario.

S407: determine 3D coordinates of body key points of a target character in an image to be detected using the detection model.

This step can be specifically implemented in the same manner as steps S201-S206 in the above-mentioned second embodiment, and will not be repeated herein.

S408: recognize a gesture or motion of the target character according to the 3D coordinates of the body key points of the target character, and performing corresponding processing according to the gesture or motion of the target character.

After the 3D coordinates of the body key points is detected, the gesture or motion of the target character can be recognized according to the final 3D coordinates of the body key points.

In different application scenarios, interaction information corresponding to the gesture or motion of the target character is different. Combined with specific application scenarios, the interaction information corresponding to the gesture or motion of the target character is determined, and corresponding processing is made based on the interaction information corresponding to the gesture or motion of the target character, and response is made with respect to the gesture or motion of the target character.

The embodiments of the present application determines the true 3D coordinates of the body key points of the character object in the sample image according to depth information of the sample image based on an original data set; perform data enhancement processing on the true 3D coordinates of the body key points of the character object in the sample image to determine the sample value of the 3D coordinates of the body key points; and determine the 3D position offset of the 3D coordinates caused by the previous data enhancement processing to obtain a new label data of the sample image, where the sample image and the new label data thereof constitute a piece of training data, so that the training set, which can be applied to the embodiments of the present application, can be obtained, and the training of the neural network provides rich training data, which improves the sample diversity in the training set; supervise the model training during the training process by comprehensively calculating loss values of the 3D coordinates and the 3D position offset of the body key points, which can improve the detection accuracy of the trained detection model on the 3D coordinates of the body key points, thereby improving the recognition accuracy of the gesture or motion of the target character in the image.

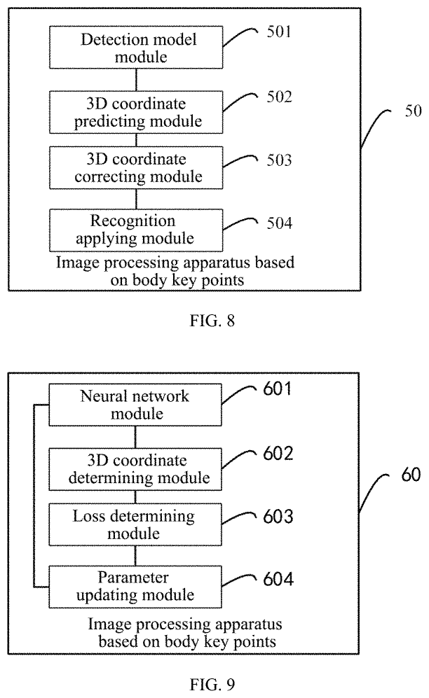

FIG. 8 is a schematic diagram of an image processing apparatus provided by a fifth embodiment of the present application. The image processing apparatus provided in the embodiment of the present application can execute the processing flow provided in the embodiment of the image processing method. As shown in FIG. 8, the image processing apparatus 50 includes: a detection model module 501, a 3D coordinate predicting module 502, a 3D coordinate correcting module 503, and a recognition applying module 504.

Specifically, the detection model module 501 is configured to, in response to a detection instruction with respect to body key points of a target character in an image to be detected, input the image to be detected into a detection model, and determine a 3D thermal distribution map and a 3D position offset of the body key points, where the detection model is obtained by training a neural network according to a training set.

The 3D coordinate predicting module 502 is configured to determine predicted 3D coordinates of the body key points according to the 3D thermal distribution map.

The 3D coordinate correcting module 503 is configured to correct the predicted 3D coordinates of the body key points according to the 3D position offset to obtain final 3D coordinates of the body key points.

The recognition applying module 504 is configured to recognize a gesture or motion of the target character according to the final 3D coordinates of the body key points, and performing corresponding processing according to the gesture or motion of the target character.

The apparatus provided in the embodiment of the present application may be specifically used to execute the method embodiment provided in the above-mentioned first embodiment, and the specific functions will not be repeated herein.

The embodiment of the present application, by determining, by a detection model, a 3D thermal distribution map and a 3D position offset of body key points of a target character in an image to be detected according to the input image to be detected, determining predicted 3D coordinates of the body key points based on the 3D thermal distribution map of the body key points, and correcting the predicted 3D coordinates according to the 3D position offset of the body key points, can obtain accurate 3D coordinates of the body key points, thereby realizing accurate detection of the body key points, and can recognize a gesture or motion of the target character accurately based on the accurate 3D coordinates of body key points, and by performing corresponding processing according to the gesture or motion of the target character, improves the recognition accuracy of the gesture or motion of the target character, can accurately recognize the intention of the target character, and can improve the interaction effect with the target character.

On the basis of the above-mentioned fifth embodiment, in a sixth embodiment of the present application, the 3D thermal distribution map is a probability distribution of the body key points in various positions of a three-dimensional space.

The 3D coordinate predicting module is further configured to: determine a maximum value of the probability distribution and 3D coordinates of a location point corresponding to the maximum value using a softargmax method; and determine the 3D coordinates of the location point corresponding to the maximum value as 3D coordinates of the body key points.

In an optional implementation, the detection model module is further configured to: extract a body key point feature in the image to be detected to obtain a first body key point feature map and an intermediate result feature map with a preset resolution; increase a resolution of the first body key point feature map to obtain a second body key point feature map with a specified resolution; transform the second body key point feature map to obtain the 3D thermal distribution map; and determine the 3D position offset of the body key points by comparing the intermediate result feature map with the second body key point feature map.

In an optional implementation, the detection model module is further configured to: pass the first body key point feature map through at least one deconvolution layer to increase the resolution of the first body key point feature map to obtain a third body key point feature map; and perform feature extraction on a body key point feature in the third body key point feature map through a 1×1 convolution layer to obtain the second body key point feature map.

In an optional implementation, the detection model module is further configured to connect the intermediate result feature map with the second body key point feature map for inputting into a convolution layer, and determine the 3D position offset of the body key points by comparing the intermediate result feature map with the second body key point feature map through the convolution layer.

The apparatus provided in the embodiment of the present application can be specifically configured to execute the method embodiment provided in the second embodiment above, and the specific functions will not be repeated herein.

The embodiment of the present application, by extracting a body key point feature in the image to be detected to obtain a first body key point feature map and an intermediate result feature map with a preset resolution; increasing a resolution of the first body key point feature map to obtain a second body key point feature map with a specified resolution; performing transformation processing on the second body key point feature map to obtain the 3D thermal distribution map; determining predicted 3D coordinates of the body key points according to the 3D thermal distribution map; and determining the 3D position offset of the body key points by comparing the intermediate result feature map with the second body key point feature map, can accurately determine the predicted 3D coordinates and the 3D position offset of the body key points; furthermore, the 3D thermal distribution map is a probability distribution of the body key points in various positions of a three-dimensional space, the embodiment of the present application, by determining a maximum value of the probability distribution and 3D coordinates of a location point corresponding to the maximum value using a softargmax method; and determining the 3D coordinates of the location point corresponding to the maximum value as 3D coordinates of the body key points, improves the accuracy of the predicted 3D coordinates and the accuracy of the 3D coordinates of the body key points, and can recognize a gesture or motion of the target character accurately based on the accurate 3D coordinates of body key points, and by performing corresponding processing according to the gesture or motion of the target character, improves the recognition accuracy of the gesture or motion of the target character, can accurately recognize the intention of the target character, and can improve the interaction effect with the target character.

FIG. 9 is a schematic diagram of an image processing apparatus provided by a seventh embodiment of the present application. The image processing apparatus provided in the embodiment of the present application can execute the processing flow provided in the embodiment of the image processing method. As shown in FIG. 9, the image processing apparatus 60 includes a neural network module 601, a 3D coordinate determining module 602, a loss determining module 603, and a parameter updating module 604.

Specifically, the neural network module 601 is configured to input a sample image in a training set into a neural network, and determine a 3D thermal distribution map and a predicted value of a 3D position offset of body key points of a character object in the sample image.

The 3D coordinate determining module 602 is configured to determine a predicted value of 3D coordinates of the body key points according to the 3D thermal distribution map of the body key points.

The loss determining module 603 is configured to calculate a loss value of the neural network according to label data of the sample image as well as the predicted value of the 3D coordinates and the predicted value of the 3D position offset of the body key points.

The parameter updating module 604 is configured to update a parameter of the neural network according to the loss value of the neural network.

The apparatus provided in the embodiment of the present application can be specifically configured to execute the method embodiment provided in the third embodiment above, and the specific functions will not be repeated herein.

The embodiment of the present application trains the detection model for the body key points by using the pre-obtained training set, where the trained detection model can accurately detect the 3D thermal distribution map and 3D position offset of the body key points of the character object in the input image, so that the accurate 3D coordinates of the body key points can be determined.

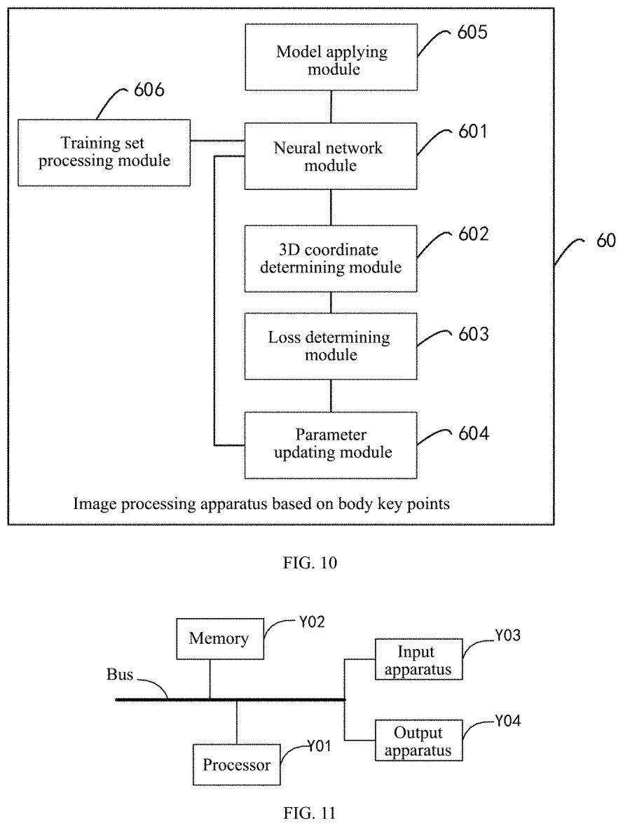

FIG. 10 is a schematic diagram of an image processing apparatus provided by an eighth embodiment of the present application. On the basis of the above seventh embodiment, in this embodiment, as shown in FIG. 10, the image processing apparatus 60 further includes: a model applying module 605. The model applying module 605 is configured to: use a trained neural network as a detection model for the body key points, and determine 3D coordinates of body key points of a target character in an image to be detected using the detection model; and recognize a gesture or motion of the target character according to the 3D coordinates of the body key points of the target character, and perform corresponding processing according to the gesture or motion of the target character.

In an optional implementation, as shown in FIG. 10, the image processing apparatus 60 further includes: a training set processing module 606. The training set processing module 606 is configured to acquire the training set, where the training set includes multiple pieces of training data, each of which includes a sample image and label data of the sample image, the label data of the sample image includes 3D coordinates and a 3D position offset of body key points of a character object in the sample image.

In an optional implementation, the training set processing module is further configured to: acquire a sample image as well as true 3D coordinates and a type of body key points of a character object in the sample image, which are pre-labeled; perform data enhancement on the true 3D coordinates of the body key points to determine a sample value of 3D coordinates of the body key points; calculate a 3D position offset of the sample value of the 3D coordinates of the body key points with respect to the true 3D coordinates; and generate label data of the sample image according to the sample value of the 3D coordinates of the body key points, the type of the body key points, which is pre-labeled, and the 3D position offset of the sample value of the 3D coordinates of the body key points with respect to the true 3D coordinates, where the sample image and the label data thereof constitute a piece of training data.

In an optional implementation, the training set processing module is further configured to: perform at least one of the following data enhancement processing on the true 3D coordinates of the body key points: exchanging true 3D coordinates of symmetrical body key points among the body key points; increasing an error value on the true 3D coordinates of the body key points according to preset rules; and taking true 3D coordinates of body key points of a first character object as a sample value of 3D coordinates of corresponding body key points of a second character object, where the first character object and the second character object are the character object in a same sample image.

In an optional implementation, the training set processing module is also configured to: after the sample image as well as the true 3D coordinates and the type of body key points of the character object in the sample image, which are pre-labeled, are acquired, set the 3D position offset of the body key points of the character object in the sample image to 0; and generate the label data of the sample image according to the true 3D coordinates and the type of the body key points of the character object in the sample image, which are pre-labeled, and the 3D position offset set to 0, where the sample image and the label data thereof constitute a piece of training data.

In an optional implementation, the loss determining module is further configured to: calculate a 3D coordinate loss and a 3D position offset loss respectively according to the label data of the sample image as well as the predicted value of the 3D coordinates and the predicted value of the 3D position offset of the body key points; and determine the loss value of the neural network according to the 3D coordinate loss and the 3D position offset loss.

In an optional implementation, the neural network module is further configured to: extract a body key point feature in the sample image to obtain a first body key point feature map and an intermediate result feature map with a preset resolution; increase a resolution of the first body key point feature map to obtain a second body key point feature map with a specified resolution; transform the second body key point feature map to obtain the 3D thermal distribution map; and determine the predicted value of the 3D position offset of the body key points by comparing the intermediate result feature map with the second body key point feature map.

In an optional implementation, the neural network module is further configured to: pass the first body key point feature map through at least one deconvolution layer to increase the resolution of the first body key point feature map to obtain a third body key point feature map; and perform feature extraction on a body key point feature in the third body key point feature map through a 1×1 convolution layer to obtain the second body key point feature map.

In an optional implementation, the neural network module is further configured to: connect the intermediate result feature map with the second body key point feature map for inputting into a convolution layer, and determine the predicted value of the 3D position offset of the body key points by comparing the intermediate result feature map with the second body key point feature map through the convolution layer.

The apparatus provided in the embodiment of the present application may be specifically configured to execute the method embodiment provided in the above-mentioned fourth embodiment, and the specific functions will not be repeated herein.

The embodiments of the present application determines the true 3D coordinates of the body key points of the character object in the sample image according to depth information of the sample image based on an original data set; perform data enhancement processing on the true 3D coordinates of the body key points of the character object in the sample image to determine the sample value of the 3D coordinates of the body key points; and determine the 3D position offset of the 3D coordinates caused by the previous data enhancement processing to obtain a new label data of the sample image, where the sample image and the new label data thereof constitute a piece of training data, so that the training set, which can be applied to the embodiments of the present application, can be obtained, and the training of the neural network provides rich training data, which improves the sample diversity in the training set; supervise the model training during the training process by comprehensively calculating loss values of the 3D coordinates and the 3D position offset of the body key points, which can improve the detection accuracy of the trained detection model on the 3D coordinates of the body key points, thereby improving the recognition accuracy of the gesture or motion of the target character in the image.

According to an embodiment of the present application, the present application further provides an electronic device and a readable storage medium.

As shown in FIG. 11, it is a block diagram of an electronic device for the image processing method according to an embodiment of the present application. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital processing, a cellular phone, a smart phone, a wearable device, and other similar computing devices. The components shown herein, their connections and relationships, and their functions are merely examples, and are not intended to limit implementations of the present application described and/or claimed herein.

As shown in FIG. 11, the electronic device includes: one or more processors Y01, a memory Y02, and an interface for connecting components, including a high-speed interface and a low-speed interface. The components are connected to each other via different buses, and can be installed on a public motherboard or installed in other ways as desired. The processor may process instructions executed within the electronic device, including instructions that stored in or on the memory to display GUI graphical information on an external input/output apparatus (such as a display device coupled to the interface). In other embodiments, multiple processors and/or multiple buses can be used together with multiple memories, if desired. Similarly, multiple electronic devices can be connected, and each device provides some necessary operations (for example, as a server array, a group of blade servers, or a multi-processor system). In FIG. 11, one processor Y01 is used as an example.

The memory Y02 is a non-transitory computer readable storage medium provided in the present application. The memory is stored with instructions executable by at least one processor, enabling at least one processor to execute the image processing method provided in the present application. The non-transitory computer readable storage medium of the present application is stored with computer instructions, which are configured to enable a computer to execute the image processing method provided in the present application.

As a kind of non-transitory computer-readable storage medium, the memory Y02 can be configured to store non-transitory software programs, non-transitory computer executable programs and modules, such as program instructions/modules corresponding to the image processing method in the embodiments of the present application (for example, the detection model module 501, the 3D coordinate predicting module 502, the 3D coordinate correcting module 503, and the recognition applying module 504 shown in FIG. 8). The processor Y01 executes various functional applications and data processing of the server by running the non-transitory software programs, instructions, and modules stored in the memory Y02, thereby implementing the image processing method in the foregoing method embodiments.

The memory Y02 may include a program storage area and a data storage area, where the program storage area may be stored with an application program required by an operating system and at least one function, the data storage area may be stored with data created according to use of the electronic device for the image processing method, and the like. In addition, the memory Y02 may include a high-speed random access memory, and may also include a non-transitory memory, such as at least one magnetic disk storage device, a flash memory device, or other non-transitory solid-state storage devices. In some embodiments, the memory Y02 optionally includes remote memories arranged relative to the processor Y01, and these remote memories can be connected to the electronic device for the image processing method through a network. Examples of the above network include, but are not limited to, Internet, an intranet, a local area network, a mobile communication network, and a combination thereof.

The electronic device for the image processing method may also include: an input apparatus Y03 and an output apparatus Y04. The processor Y01, the memory Y02, the input apparatus Y03 and the output apparatus Y04 can be connected by a bus or in other ways, in FIG. 11, connections via buses are used as an example.

The input apparatus Y03 may receive input digital or character information, and generate key signal input related to user settings and function control of the electronic device for the image processing method, such as a touch screen, a keypad, a mouse, a trackpad, a touchpad, an indicator bar, one or more mouse buttons, a trackball, a joystick and other input apparatuses. The output apparatus Y04 may include a display device, an auxiliary lighting device (e. g., an LED), a tactile feedback device (e. g., a vibration motor), and the like. The display device may include, but is not limited to, a liquid crystal display (LCD), a light emitting diode (LED) display, and a plasma display. In some implementations, the display device may be the touch screen.

Various implementations of the system and the technique described herein may be implemented in a digital electronic circuit system, an integrated circuit system, an ASIC (application specific integrated circuit), a computer hardware, a firmware, a software, and/or a combination thereof. These various implementations may include: implementations implemented in one or more computer programs, where the one or more computer programs may be executed and/or interpreted on a programmable system including at least one programmable processor, and the programmable processor may be a dedicated or generic programmable processor, which may receive data and instructions from a storage system, at least one input apparatus and at least one output apparatus, and transmit the data and the instructions to the storage system, the at least one input apparatus and the at least one output apparatus.

These computer programs (also known as programs, software, software applications, or codes) include machine instructions of the programmable processor, and may be implemented using a high-level process and/or an object-oriented programming language, and/or an assembly/machine language. As used herein, the terms such as “machine readable medium” and “computer readable medium” refer to any computer program product, device, and/or equipment (e.g., a magnetic disk, an optical disk, a memory, a programmable logic device (PLD)) configured to provide machine instructions and/or data to the programmable processor, including a machine readable medium that receives machine instructions as machine readable signals. The term “machine readable signal” refers to any signal configured to provide machine instructions and/or data to the programmable processor.

For provision of interaction with a user, the system and the technique described herein may be implemented on a computer, and the computer has: a display device for displaying information to the user (such as a CRT (cathode ray tube) or an LCD (liquid crystal display) monitor); and a keyboard and a pointing device (such as a mouse or a trackball), the user may provide an input to the computer through the keyboard and the pointing device. Other kinds of devices may also be used to provide the interaction with the user; for example, feedback provided to the user may be any form of sensor feedback (e.g., visual feedback, auditory feedback, or tactile feedback); and may receive the input from the user in any form (including an acoustic input, a voice input, or a tactile input).

The system and the technique described herein may be implemented in a computing system that includes back-end components (for example, as a data server), or a computing system that includes intermediate components (for example, an application server), or a computing system that includes front-end components (for example, a user computer with a graphical user interface or a web browser through which the user may interact with the implementations of the systems and the techniques described herein), or a computing system that includes any combination of the back-end components, the intermediate components, or the front-end components. The components of the system may be interconnected by any form or medium of digital data communications (e.g., a communication network). Examples of the communication network include: a local area network (LAN), a wide area network (WAN), and Internet.

The computer system may include a client and a server. The client and the server are generally far away from each other, and generally interact with each other through the communication network. A relationship between the client and the server is generated by computer programs running on a corresponding computer and having a client-server relationship. The server can be a cloud server, also known as a cloud computing server or a cloud host. It is a host product in a cloud computing service system to solve shortcomings of traditional physical hosting and VPS services (“Virtual Private Server”, or “VPS” for short), which are difficulty in management and weakness in business scalability. The server can also be a server of a distributed system, or a server combined with a block chain.

It should be understood that the various forms of processes shown above can be used, and reordering, addition, or deletion of a step can be performed. For example, the steps recorded in the present application can be executed concurrently, sequentially, or in different orders, provided that desirable results of the technical solutions disclosed in the present application could be achieved, and there is no limitation herein.

The above specific embodiments do not constitute a limitation on the protection scope of the present application. Those skilled in the art should understand that various modifications, combinations, sub-combinations, and replacements can be made according to design requirements and other factors. Any modification, equivalent replacement and improvement made within the spirit and principle of the present application shall be included in the protection scope of the present application.

What is claimed is:

1. An image processing method, comprising:
in response to a detection instruction with respect to body key points of a target character in an image to be detected, inputting the image to be detected into a detection model, and determining a 3D thermal distribution map and a 3D position offset of the body key points, wherein the detection model is obtained by training a neural network according to a training set;
determining predicted 3D coordinates of the body key points according to the 3D thermal distribution map;
correcting the predicted 3D coordinates of the body key points according to the 3D position offset to obtain final 3D coordinates of the body key points; and
recognizing a gesture or motion of the target character according to the final 3D coordinates of the body key points, and performing corresponding processing according to the gesture or motion of the target character.

2. The method according to claim 1, wherein the 3D thermal distribution map is a probability distribution of the body key points in various positions of a three-dimensional space,
the determining predicted 3D coordinates of the body key points according to the 3D thermal distribution map comprises:
determining a maximum value of the probability distribution and 3D coordinates of a location point corresponding to the maximum value using a softargmax method; and
determining the 3D coordinates of the location point corresponding to the maximum value as 3D coordinates of the body key points.

3. The method according to claim 1, wherein the inputting the image to be detected into a detection model, and determining a 3D thermal distribution map and a 3D position offset of the body key points comprises:
extracting a body key point feature in the image to be detected to obtain a first body key point feature map and an intermediate result feature map with a preset resolution;
increasing a resolution of the first body key point feature map to obtain a second body key point feature map with a specified resolution;
performing transformation processing on the second body key point feature map to obtain the 3D thermal distribution map; and
determining the 3D position offset of the body key points by comparing the intermediate result feature map with the second body key point feature map;
wherein the increasing a resolution of the first body key point feature map to obtain a second body key point feature map with a specified resolution comprises:
passing the first body key point feature map through at least one deconvolution layer to increase the resolution of the first body key point feature map to obtain a third body key point feature map; and
performing feature extraction on a body key point feature in the third body key point feature map through a 1×1 convolution layer to obtain the second body key point feature map;
wherein determining the 3D position offset of the body key points by comparing the intermediate result feature map with the second body key point feature map comprises:
connecting the intermediate result feature map with the second body key point feature map for inputting into a convolution layer, and determining the 3D position offset of the body key points by comparing the intermediate result feature map with the second body key point feature map through the convolution layer.

4. An image processing method, comprising:
inputting a sample image in a training set into a neural network, and determining a 3D thermal distribution map and a predicted value of a 3D position offset of body key points of a character object in the sample image;
determining a predicted value of 3D coordinates of the body key points according to the 3D thermal distribution map of the body key points;
calculating a loss value of the neural network according to label data of the sample image as well as the predicted value of the 3D coordinates and the predicted value of the 3D position offset of the body key points; and
updating a parameter of the neural network according to the loss value of the neural network.

5. The method according to claim 4, wherein after the updating a parameter of the neural network according to the loss value of the neural network, the method further comprises:
using a trained neural network as a detection model for the body key points, and determining 3D coordinates of body key points of a target character in an image to be detected using the detection model; and
recognizing a gesture or motion of the target character according to the 3D coordinates of the body key points of the target character, and performing corresponding processing according to the gesture or motion of the target character.

6. The method according to claim 4, wherein before the inputting a sample image in a training set into a neural network, and determining a 3D thermal distribution map and a predicted value of a 3D position offset of body key points of a character object in the sample image, the method further comprises:
acquiring the training set, wherein the training set comprises multiple pieces of training data, each of which comprises a sample image and label data of the sample image, the label data of the sample image comprises 3D coordinates and a 3D position offset of body key points of a character object in the sample image.

7. The method according to claim 6, wherein the acquiring the training set comprises:
acquiring a sample image as well as true 3D coordinates and a type of body key points of a character object in the sample image, which are pre-labeled;
performing data enhancement on the true 3D coordinates of the body key points to determine a sample value of 3D coordinates of the body key points;
calculating a 3D position offset of the sample value of the 3D coordinates of the body key points with respect to the true 3D coordinates; and
generating label data of the sample image according to the sample value of the 3D coordinates of the body key points, the type of the body key points, which is pre-labeled, and the 3D position offset of the sample value of the 3D coordinates of the body key points with respect to the true 3D coordinates, wherein the sample image and the label data thereof constitute a piece of training data.

8. The method according to claim 7, wherein at least one of the following data enhancement processing is performed on the true 3D coordinates of the body key points:
exchanging true 3D coordinates of symmetrical body key points among the body key points;
increasing an error value on the true 3D coordinates of the body key points according to preset rules; and
taking true 3D coordinates of body key points of a first character object as a sample value of 3D coordinates of corresponding body key points of a second character object, wherein the first character object and the second character object are the character object in a same sample image.

9. The method according to claim 7, wherein after the acquiring a sample image as well as true 3D coordinates and a type of body key points of a character object in the sample image, which are pre-labeled, the method further comprises:
setting the 3D position offset of the body key points of the character object in the sample image to 0; and
generating the label data of the sample image according to the true 3D coordinates and the type of the body key points of the character object in the sample image, which are pre-labeled, and the 3D position offset set to 0, wherein the sample image and the label data thereof constitute a piece of training data.

10. The method according to claim 4, wherein the calculating a loss value of the neural network according to label data of the sample image as well as the predicted value of the 3D coordinates and the predicted value of the 3D position offset of the body key points comprises:
calculating a 3D coordinate loss and a 3D position offset loss respectively according to the label data of the sample image as well as the predicted value of the 3D coordinates and the predicted value of the 3D position offset of the body key points; and
determining the loss value of the neural network according to the 3D coordinate loss and the 3D position offset loss.

11. The method according to claim 10, wherein the inputting a sample image in a training set into a neural network, and determining a 3D thermal distribution map and a predicted value of a 3D position offset of body key points of a character object in the sample image comprises:
extracting a body key point feature in the sample image to obtain a first body key point feature map and an intermediate result feature map with a preset resolution;
increasing a resolution of the first body key point feature map to obtain a second body key point feature map with a specified resolution;
performing transformation processing on the second body key point feature map to obtain the 3D thermal distribution map; and
determining the predicted value of the 3D position offset of the body key points by comparing the intermediate result feature map with the second body key point feature map;
wherein the increasing a resolution of the first body key point feature map to obtain a second body key point feature map with a specified resolution, comprises:
passing the first body key point feature map through at least one deconvolution layer to increase the resolution of the first body key point feature map to obtain a third body key point feature map; and
performing feature extraction on a body key point feature in the third body key point feature map through a 1×1 convolution layer to obtain the second body key point feature map;
wherein the determining the predicted value of the 3D position offset of the body key points by comparing the intermediate result feature map with the second body key point feature map comprises:
connecting the intermediate result feature map with the second body key point feature map for inputting into a convolution layer, and determining the predicted value of the 3D position offset of the body key points by comparing the intermediate result feature map with the second body key point feature map through the convolution layer.

12. An image processing apparatus, comprising:
at least one processor; and
a memory communicatively connected to the at least one processor; wherein,
the memory stores instructions executable by the at least one processor, and the instructions are executed by the at least one processor to enable the at least one processor to execute the method according to claim 1.

13. An image processing apparatus, comprising:
at least one processor; and
a memory communicatively connected to the at least one processor; wherein,
the memory stores instructions executable by the at least one processor, and the instructions are executed by the at least one processor, so that the at least one processor is configured to:
input a sample image in a training set into a neural network, and determine a 3D thermal distribution map and a predicted value of a 3D position offset of body key points of a character object in the sample image;
determine a predicted value of 3D coordinates of the body key points according to the 3D thermal distribution map of the body key points;
calculate a loss value of the neural network according to label data of the sample image as well as the predicted value of the 3D coordinates and the predicted value of the 3D position offset of the body key points; and
update a parameter of the neural network according to the loss value of the neural network.

14. The apparatus according to claim 13, further comprising: a model applying module, the model applying module configured to:
use a trained neural network as a detection model for the body key points, and determine 3D coordinates of body key points of a target character in an image to be detected using the detection model; and
recognize a gesture or motion of the target character according to the 3D coordinates of the body key points of the target character, and perform corresponding processing according to the gesture or motion of the target character.

15. The apparatus according to claim 13, wherein the at least one processor is further configured to:
acquire the training set, wherein the training set comprises multiple pieces of training data, each of which comprises a sample image and label data of the sample image, the label data of the sample image comprises 3D coordinates and a 3D position offset of body key points of a character object in the sample image.

16. The apparatus according to claim 15, wherein the at least one processor is further configured to:
acquire a sample image as well as true 3D coordinates and a type of body key points of a character object in the sample image, which are pre-labeled;
perform data enhancement on the true 3D coordinates of the body key points to determine a sample value of 3D coordinates of the body key points;
calculate a 3D position offset of the sample value of the 3D coordinates of the body key points with respect to the true 3D coordinates; and
generate label data of the sample image according to the sample value of the 3D coordinates of the body key points, the type of the body key points, which is pre-labeled, and the 3D position offset of the sample value of the 3D coordinates of the body key points with respect to the true 3D coordinates, wherein the sample image and the label data thereof constitute a piece of training data.

17. The apparatus according to claim 16, wherein the at least one processor is further configured to:
perform at least one of the following data enhancement processing on the true 3D coordinates of the body key points:
exchanging true 3D coordinates of symmetrical body key points among the body key points;
increasing an error value on the true 3D coordinates of the body key points according to preset rules; and
taking true 3D coordinates of body key points of a first character object as a sample value of 3D coordinates of corresponding body key points of a second character object, wherein the first character object and the second character object are the character object in a same sample image.

18. The apparatus according to claim 16, wherein the at least one processor is further configured to:
after the sample image as well as the true 3D coordinates and the type of body key points of the character object in the sample image, which are pre-labeled, are acquired,
set the 3D position offset of the body key points of the character object in the sample image to 0; and
generate the label data of the sample image according to the true 3D coordinates and the type of the body key points of the character object in the sample image, which are pre-labeled, and the 3D position offset set to 0, wherein the sample image and the label data thereof constitute a piece of training data.

19. The apparatus according to claim 13, wherein the loss determining module is further configured to:
calculate a 3D coordinate loss and a 3D position offset loss respectively according to the label data of the sample image as well as the predicted value of the 3D coordinates and the predicted value of the 3D position offset of the body key points;
determine the loss value of the neural network according to the 3D coordinate loss and the 3D position offset loss;
extract a body key point feature in the sample image to obtain a first body key point feature map and an intermediate result feature map with a preset resolution;
increase a resolution of the first body key point feature map to obtain a second body key point feature map with a specified resolution;
transform the second body key point feature map to obtain the 3D thermal distribution map; and
determine the predicted value of the 3D position offset of the body key points by comparing the intermediate result feature map with the second body key point feature map.
wherein the at least one processor is further configured to:
pass the first body key point feature map through at least one deconvolution layer to increase the resolution of the first body key point feature map to obtain a third body key point feature map; and
perform feature extraction on a body key point feature in the third body key point feature map through a 1×1 convolution layer to obtain the second body key point feature map.
wherein the at least one processor is further configured to:
connect the intermediate result feature map with the second body key point feature map for inputting into a convolution layer, and determine the predicted value of the 3D position offset of the body key points by comparing the intermediate result feature map with the second body key point feature map through the convolution layer.

20. A non-transitory computer-readable storage medium, having computer instructions stored thereon, wherein the computer instructions are used to cause a computer to execute the method according to claim 1.
